(19) United States
(12) Patent Application Publication
(10) Pub. No.: US 2024/0057494 A1
(43) Pub. Date: Feb. 22, 2024

(54) WEAR BLOCK ASSEMBLY FOR A THREE-POINT HITCH

(71) Applicant: CNH Industrial America LLC, New Holland, PA (US)

(72) Inventors: Chad Sietsema, New Holland, PA (US); John T. Rasset, New Holland, PA (US); Jason Novacek, New Holland, PA (US)

(73) Assignee: CNH Industrial America LLC, New Holland, PA (US)

(21) Appl. No.: 17/892,909

(22) Filed: Aug. 22, 2022

(51) Int. Cl. A01B 59/00; A01B 59/06

(52) U.S. Cl. CPC A01B 59/002; A01B 59/066

(57) ABSTRACT

A wear block assembly includes a wedge block having a top surface and a bottom surface, and a wear block having a tooth that protrudes from a contact surface. The top surface of the wedge block includes a wedge recess that extends laterally along the top surface. The tooth is configured to be received within the recess and engage a securing face of the recess to interlock the wedge block and the wear block.

### BACKGROUND

The present disclosure relates generally to a wear block assembly for a three-point hitch. Certain work vehicles, such as tractors, include a three-point hitch configured to engage and couple to a towed implement.

### SUMMARY

One embodiment relates to a wear block assembly for a three-point hitch. The wear block assembly includes a wedge block having a top surface and a bottom surface. The top surface includes a wedge recess that extends laterally along the top surface. The wear block assembly further includes a wear block having a tooth that protrudes from a contact surface. The tooth is configured to be received within the wedge recess and engage a securing face of the wedge recess to interlock the wedge block and the wear block.

Another embodiment relates to a wear block assembly for a three-point hitch. The wear block assembly includes a wedge block having a first end, a second end, a bottom surface, and a top surface. The top surface includes a plurality of wedge recesses, each extending laterally along the top surface and being spaced from one another along a longitudinal direction between the first end and the second end. The wear block assembly further includes a wear block having a wear surface, a contact surface, and a tooth that protrudes from the contact surface. The tooth is configured to be received within one of the plurality of wedge recesses. Each of the plurality of wedge recesses defines a different height of the wear surface relative to the bottom surface.

Still another embodiment relates to a three-point hitch for a vehicle. The three-point hitch includes a frame having a sway surface, and a draft arm having a wear block assembly. The wear block assembly includes a wedge block having a first end, a second end, a bottom surface, and a top surface. The top surface includes a plurality of wedge recesses, each extending laterally along the top surface and being spaced from one another along a longitudinal direction between the first end and the second end. The wear block assembly further includes a wear block having a wear surface configured to engage the sway surface, a contact surface, and a tooth that protrudes from the contact surface. The tooth is configured to be received within one of the plurality of wedge recesses. Each of the plurality of wedge recesses defines a different lateral position of the wear surface relative to the draft arm.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

### BRIEF DESCRIPTION OF THE DRAWINGS

FIG. 1 is a perspective view of a vehicle, according to an exemplary embodiment.

FIG. 2 is a schematic block diagram of the vehicle of FIG. 1, according to an exemplary embodiment.

FIG. 3 is a schematic block diagram of a driveline of the vehicle of FIG. 1, according to an exemplary embodiment.

FIG. 4 is a side view of a vehicle coupled to an implement using a three-point hitch, according to an exemplary embodiment.

FIG. 5 is a top perspective view of a three-point hitch, according to an exemplary embodiment.

FIG. 6 is a top view of the three-point hitch of FIG. 5.

FIG. 7 is an enlarged perspective view of a wear block assembly installed on the three-point hitch of FIG. 5.

FIG. 8 is top perspective view of a wear block assembly and a draft arm of the three-point hitch of FIG. 5.

FIG. 9 is an exploded view of the wear block assembly and the draft arm of FIG. 8.

FIG. 10 is a top view of the wear block assembly and the draft arm of FIG. 8.

FIG. 11 is a top perspective view of a wear block of the wear block assembly of FIG. 8.

FIG. 12 is a bottom perspective view of the wear block of FIG. 11.

FIG. 13 is a bottom view of the wear block of FIG. 11.

FIG. 14 is a cross-sectional view of the wear block of FIG. 13 taken along line 14-14.

FIG. 15 is an enlarged view of a tooth of the wear block of FIG. 14.

FIG. 16 is a top perspective view of a wedge block of the wear block assembly of FIG. 8.

FIG. 17 is a side view of the wedge block of FIG. 16.

FIG. 18 is an enlarged view of wedge recessed formed in the wedge block of FIG. 17.

FIG. 19 is a cross-sectional view of the wear block assembly and the draft arm of FIG. 10 taken along line 19-19.

FIG. 20 is a partial cross-sectional view of the wear block assembly and the draft arm of FIG. 10 taken along line 20-20.

FIG. 21 is an enlarged view of the wear block assembly of FIG. 19.

FIG. 22 is an enlarged view of a tooth of a wear block engaging a wedge recess of a wedge block in the wear block assembly of FIG. 21.

### DETAILED DESCRIPTION

Before turning to the figures, which illustrate certain exemplary embodiments in detail, it should be understood that the present disclosure is not limited to the details or methodology set forth in the description or illustrated in the figures. It should also be understood that the terminology used herein is for the purpose of description only and should not be regarded as limiting.

In general, off-road or agricultural vehicles utilize a three-point hitch to couple work implements to the vehicle. Conventional three-point hitch designs include draft arms that rotatably couple the work implement to the chassis of the vehicle. A wear block assembly, including a wedge block and a wear block, is typically arranged between each of the draft arms and a frame on the three-point hitch. During operation, the draft arms can experience high side loading (e.g., lateral loading), for example, during heavy tillage, that results in relative displacement between the wedge blocks and the draft arms. This displacement alters the lateral clearance between the wear blocks and the frame, which can result in undesired lateral movement of the draft arms relative to the frame. Conventional wear block assemblies require the use of shims that are installed between the wear blocks and the wedge blocks to reduce the clearance between the wear block assemblies and the frame and, thereby, reduce the lateral movement of the draft arms. But the use of shims requires an additional component to facilitate adjustment of the wear block, which increases cost and the amount of time required to adjust the lateral movement of the draft arms.

According to an exemplary embodiment, a wear block assembly of the present disclosure includes a positive locking feature that interlocks with a negative locking feature to lock a position of a wedge block relative to a draft arm on a three-point hitch, and to enable incremental adjustment of a lateral position of a wear block without the use of additional components (e.g., shims). In some embodiments, the positive locking feature includes a tooth or protrusion extending from a surface of the wear block, and the negative locking feature includes a groove or recess extending into a surface of the wedge block. The tooth on the wear block is configured to be received within the recess on the wedge block so that a locking face of the tooth engages with a securing face of the recess. The engagement between the locking face and the securing face locks the position of the wedge block relative to the draft arm. In addition, a user may quickly loosen the wear block to remove the tooth from the recess and then move the wedge block to align the tooth with an adjacent recess on the wedge block. In this way, for example, a user may quickly adjust a lateral position of the wear block relative to the draft arm, which controls an amount lateral movement allowed by the draft arm during operation. The lateral adjustment of the wear block can be quickly accomplished by simply loosening a fastening element (e.g., a bolt or nut) and does not require additional components be installed into the wear block assembly (e.g., shims).

### Overall Vehicle

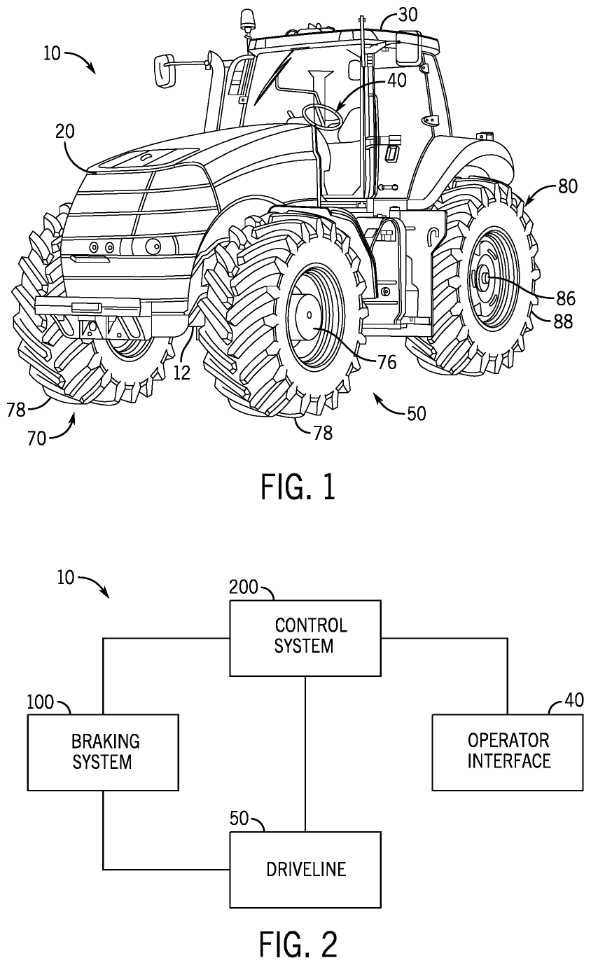

According to the exemplary embodiment shown in FIGS. 1-3, a machine or vehicle, shown as vehicle 10, includes a chassis, shown as frame 12; a body assembly, shown as body 20, coupled to the frame 12 and having an occupant portion or section, shown as cab 30; operator input and output devices, shown as operator interface 40, that are disposed within the cab 30; a drivetrain, shown as driveline 50, coupled to the frame 12 and at least partially disposed under the body 20; a vehicle braking system, shown as braking system 100, coupled to one or more components of the driveline 50 to facilitate selectively braking the one or more components of the driveline 50; and a vehicle control system, shown as control system 200, coupled to the operator interface 40, the driveline 50, and the braking system 100. In other embodiments, the vehicle 10 includes more or fewer components.

According to an exemplary embodiment, the vehicle 10 is an off-road machine or vehicle. In some embodiments, the off-road machine or vehicle is an agricultural machine or vehicle such as a tractor, a telehandler, a front loader, a combine harvester, a grape harvester, a forage harvester, a sprayer vehicle, a speedrower, and/or another type of agricultural machine or vehicle. In some embodiments, the off-road machine or vehicle is a construction machine or vehicle such as a skid steer loader, an excavator, a backhoe loader, a wheel loader, a bulldozer, a telehandler, a motor grader, and/or another type of construction machine or vehicle. In some embodiments, the vehicle 10 includes one or more attached implements and/or trailed implements such as a front mounted mower, a rear mounted mower, a trailed mower, a tedder, a rake, a baler, a plough, a cultivator, a rotavator, a tiller, a harvester, and/or another type of attached implement or trailed implement.

According to an exemplary embodiment, the cab 30 is configured to provide seating for an operator (e.g., a driver, etc.) of the vehicle 10. In some embodiments, the cab 30 is configured to provide seating for one or more passengers of the vehicle 10. According to an exemplary embodiment, the operator interface 40 is configured to provide an operator with the ability to control one or more functions of and/or provide commands to the vehicle 10 and the components thereof (e.g., turn on, turn off, drive, turn, brake, engage various operating modes, raise/lower an implement, etc.). The operator interface 40 may include one or more displays and one or more input devices. The one or more displays may be or include a touchscreen, a LCD display, a LED display, a speedometer, gauges, warning lights, etc. The one or more input device may be or include a steering wheel, a joystick, buttons, switches, knobs, levers, an accelerator pedal, a brake pedal, etc.

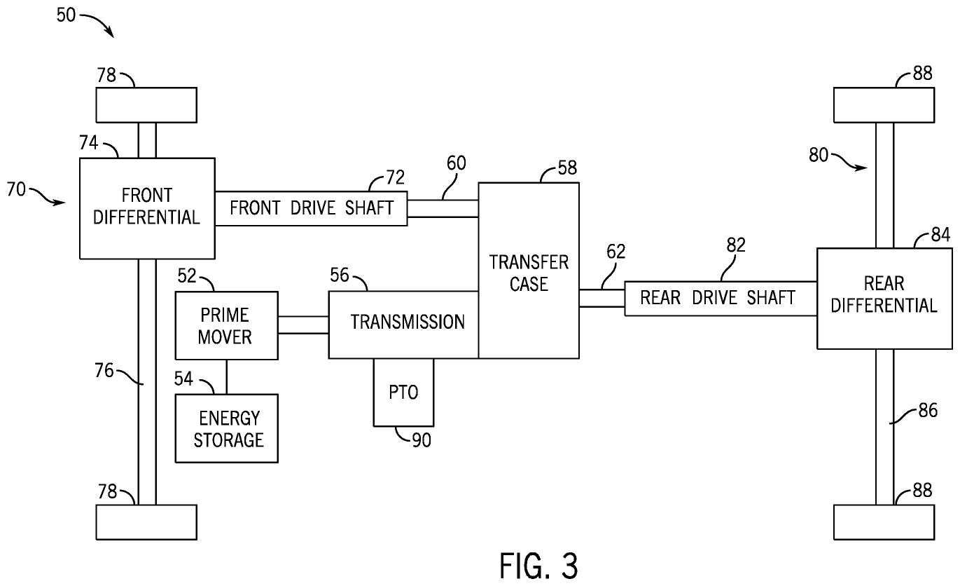

According to an exemplary embodiment, the driveline 50 is configured to propel the vehicle 10. As shown in FIG. 3, the driveline 50 includes a primary driver, shown as prime mover 52, and an energy storage device, shown as energy storage 54. In some embodiments, the driveline 50 is a conventional driveline whereby the prime mover 52 is an internal combustion engine and the energy storage 54 is a fuel tank. The internal combustion engine may be a spark-ignition internal combustion engine or a compression-ignition internal combustion engine that may use any suitable fuel type (e.g., diesel, ethanol, gasoline, natural gas, propane, etc.). In some embodiments, the driveline 50 is an electric driveline whereby the prime mover 52 is an electric motor and the energy storage 54 is a battery system. In some embodiments, the driveline 50 is a fuel cell electric driveline whereby the prime mover 52 is an electric motor and the energy storage 54 is a fuel cell (e.g., that stores hydrogen, that produces electricity from the hydrogen, etc.). In some embodiments, the driveline 50 is a hybrid driveline whereby (i) the prime mover 52 includes an internal combustion engine and an electric motor/generator and (ii) the energy storage 54 includes a fuel tank and/or a battery system.

As shown in FIG. 3, the driveline 50 includes a transmission device (e.g., a gearbox, a continuous variable transmission (“CVT”), etc.), shown as transmission 56, coupled to the prime mover 52; a power divider, shown as transfer case 58, coupled to the transmission 56; a first tractive assembly, shown as front tractive assembly 70, coupled to a first output of the transfer case 58, shown as front output 60; and a second tractive assembly, shown as rear tractive assembly 80, coupled to a second output of the transfer case 58, shown as rear output 62. According to an exemplary embodiment, the transmission 56 has a variety of configurations (e.g., gear ratios, etc.) and provides different output speeds relative to a mechanical input received thereby from the prime mover 52. In some embodiments (e.g., in electric driveline configurations, in hybrid driveline configurations, etc.), the driveline 50 does not include the transmission 56. In such embodiments, the prime mover 52 may be directly coupled to the transfer case 58. According to an exemplary embodiment, the transfer case 58 is configured to facilitate driving both the front tractive assembly 70 and the rear tractive assembly 80 with the prime mover 52 to facilitate front and rear drive (e.g., an all-wheel-drive vehicle, a four-wheel-drive vehicle, etc.). In some embodiments, the transfer case 58 facilitates selectively engaging rear drive only, front drive only, and both front and rear drive simultaneously. In some embodiments, the transmission 56 and/or the transfer case 58 facilitate selectively disengaging the front tractive assembly 70 and the rear tractive assembly 80 from the prime mover 52 (e.g., to permit free movement of the front tractive assembly 70 and the rear tractive assembly 80 in a neutral mode of operation). In some embodiments, the driveline 50 does not include the transfer case 58. In such embodiments, the prime mover 52 or the transmission 56 may directly drive the front tractive assembly 70 (i.e., a front-wheel-drive vehicle) or the rear tractive assembly 80 (i.e., a rear-wheel-drive vehicle).

As shown in FIGS. 1 and 3, the front tractive assembly 70 includes a first drive shaft, shown as front drive shaft 72, coupled to the front output 60 of the transfer case 58; a first differential, shown as front differential 74, coupled to the front drive shaft 72; a first axle, shown front axle 76, coupled to the front differential 74; and a first pair of tractive elements, shown as front tractive elements 78, coupled to the front axle 76. In some embodiments, the front tractive assembly 70 includes a plurality of front axles 76. In some embodiments, the front tractive assembly 70 does not include the front drive shaft 72 or the front differential 74 (e.g., a rear-wheel-drive vehicle). In some embodiments, the front drive shaft 72 is directly coupled to the transmission 56 (e.g., in a front-wheel-drive vehicle, in embodiments where the driveline 50 does not include the transfer case 58, etc.) or the prime mover 52 (e.g., in a front-wheel-drive vehicle, in embodiments where the driveline 50 does not include the transfer case 58 or the transmission 56, etc.). The front axle 76 may include one or more components.

As shown in FIGS. 1 and 3, the rear tractive assembly 80 includes a second drive shaft, shown as rear drive shaft 82, coupled to the rear output 62 of the transfer case 58; a second differential, shown as rear differential 84, coupled to the rear drive shaft 82; a second axle, shown rear axle 86, coupled to the rear differential 84; and a second pair of tractive elements, shown as rear tractive elements 88, coupled to the rear axle 86. In some embodiments, the rear tractive assembly 80 includes a plurality of rear axles 86. In some embodiments, the rear tractive assembly 80 does not include the rear drive shaft 82 or the rear differential 84 (e.g., a front-wheel-drive vehicle). In some embodiments, the rear drive shaft 82 is directly coupled to the transmission 56 (e.g., in a rear-wheel-drive vehicle, in embodiments where the driveline 50 does not include the transfer case 58, etc.) or the prime mover 52 (e.g., in a rear-wheel-drive vehicle, in embodiments where the driveline 50 does not include the transfer case 58 or the transmission 56, etc.). The rear axle 86 may include one or more components. According to the exemplary embodiment shown in FIG. 1, the front tractive elements 78 and the rear tractive elements 88 are structured as wheels. In other embodiments, the front tractive elements 78 and the rear tractive elements 88 are otherwise structured (e.g., tracks, etc.). In some embodiments, the front tractive elements 78 and the rear tractive elements 88 are both steerable. In other embodiments, only one of the front tractive elements 78 or the rear tractive elements 88 is steerable. In still other embodiments, both the front tractive elements 78 and the rear tractive elements 88 are fixed and not steerable.

In some embodiments, the driveline 50 includes a plurality of prime movers 52. By way of example, the driveline 50 may include a first prime mover 52 that drives the front tractive assembly 70 and a second prime mover 52 that drives the rear tractive assembly 80. By way of another example, the driveline 50 may include a first prime mover 52 that drives a first one of the front tractive elements 78, a second prime mover 52 that drives a second one of the front tractive elements 78, a third prime mover 52 that drives a first one of the rear tractive elements 88, and/or a fourth prime mover 52 that drives a second one of the rear tractive elements 88. By way of still another example, the driveline 50 may include a first prime mover that drives the front tractive assembly 70, a second prime mover 52 that drives a first one of the rear tractive elements 88, and a third prime mover 52 that drives a second one of the rear tractive elements 88. By way of yet another example, the driveline 50 may include a first prime mover that drives the rear tractive assembly 80, a second prime mover 52 that drives a first one of the front tractive elements 78, and a third prime mover 52 that drives a second one of the front tractive elements 78. In such embodiments, the driveline 50 may not include the transmission 56 or the transfer case 58.

As shown in FIG. 3, the driveline 50 includes a power-take-off (“PTO”), shown as PTO 90. While the PTO 90 is shown as being an output of the transmission 56, in other embodiments the PTO 90 may be an output of the prime mover 52, the transmission 56, and/or the transfer case 58. According to an exemplary embodiment, the PTO 90 is configured to facilitate driving an attached implement and/or a trailed implement of the vehicle 10. In some embodiments, the driveline 50 includes a PTO clutch positioned to selectively decouple the driveline 50 from the attached implement and/or the trailed implement of the vehicle 10 (e.g., so that the attached implement and/or the trailed implement is only operated when desired, etc.).

According to an exemplary embodiment, the braking system 100 includes one or more brakes (e.g., disc brakes, drum brakes, in-board brakes, axle brakes, etc.) positioned to facilitate selectively braking (i) one or more components of the driveline 50 and/or (ii) one or more components of a trailed implement. In some embodiments, the one or more brakes include (i) one or more front brakes positioned to facilitate braking one or more components of the front tractive assembly 70 and (ii) one or more rear brakes positioned to facilitate braking one or more components of the rear tractive assembly 80. In some embodiments, the one or more brakes include only the one or more front brakes. In some embodiments, the one or more brakes include only the one or more rear brakes. In some embodiments, the one or more front brakes include two front brakes, one positioned to facilitate braking each of the front tractive elements 78. In some embodiments, the one or more front brakes include at least one front brake positioned to facilitate braking the front axle 76. In some embodiments, the one or more rear brakes include two rear brakes, one positioned to facilitate braking each of the rear tractive elements 88. In some embodiments, the one or more rear brakes include at least one rear brake positioned to facilitate braking the rear axle 86. Accordingly, the braking system 100 may include one or more brakes to facilitate braking the front axle 76, the front tractive elements 78, the rear axle 86, and/or the rear tractive elements 88. In some embodiments, the one or more brakes additionally include one or more trailer brakes of a trailed implement attached to the vehicle 10. The trailer brakes are positioned to facilitate selectively braking one or more axles and/or one more tractive elements (e.g., wheels, etc.) of the trailed implement.

Three-Point Hitch with Adjustable Wear Block Assembly

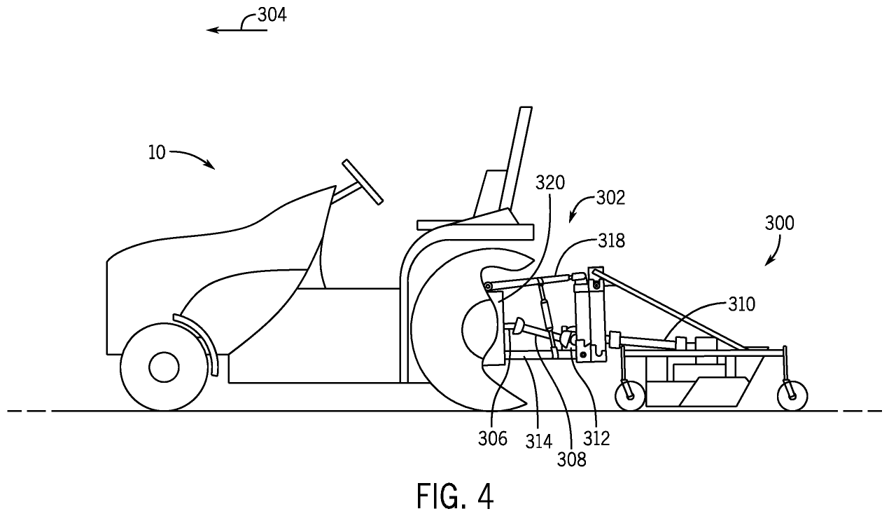

As described herein, the vehicle 10 may be coupled to one or more attached implements and/or trailed implements. FIG. 4 illustrates an embodiment of the vehicle 10 coupled to an implement 300 via a hitch, shown as three-point hitch 302. The vehicle 10 is configured to tow the implement 300 (e.g., through a field) along a direction of travel 304. In the illustrated embodiment, the implement 300 is a powered implement, such as a spreader, a rotary mower, or a rotary tiller. The implement 300 is powered by a power-take off (PTO) shaft 306 that is coupled to the PTO 90, so that rotation of the PTO shaft 306 drives rotation of one or more rotary components of the implement 300 (e.g., a rotary spreader system, mower blades, or a rotary tillage assembly, etc.). In the illustrated embodiment, the PTO shaft 306 includes a telescoping portion 308 (e.g., a telescoping actuator or linear actuator) configured to facilitate adjustment of a length of the PTO shaft 306 to accommodate different types of powered implements. However, in other embodiments, the vehicle 10 may include a non-telescoping PTO shaft. The PTO shaft 306 is coupled to a corresponding shaft 310 of the implement 300, and the corresponding shaft 310 of the implement 300 is configured to drive rotation of the rotary component(s) of the implement 300. The PTO shaft 306 and the corresponding shaft 310 of the implement 300 are coupled to one another via a connection assembly 312. The connection assembly 312 may include one or more gears, bearings, collars, joints, and/or other equivalent coupling mechanisms configured to couple the PTO shaft 306 to the corresponding shaft 310, such that rotation of the PTO shaft 306 drives the corresponding shaft 310 to rotate. In some embodiments, the implement 300 may be a non-powered implement, such as a vertical tillage implement, a primary tillage implement, a seeding implement, or a finishing implement. In such embodiments, the PTO shaft 306 of the vehicle 10 may not be coupled to a corresponding shaft 310 of the implement 300, or the vehicle 10 may not include a PTO shaft 306.

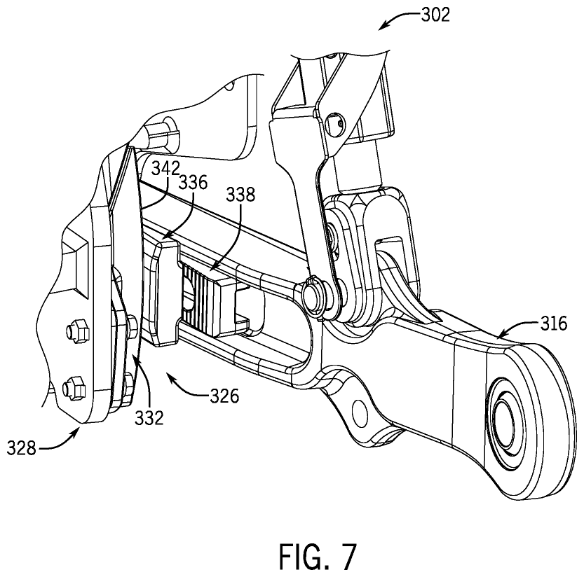

With reference to FIGS. 4-7, the three-point hitch 302 includes a first draft arm 314, a second draft arm 316, and an upper link 318. The first draft arm 314 and the second draft arm 316 are coupled (e.g., rotatably coupled) to a chassis 320 of the vehicle 10 (see, e.g., FIG. 4). In some embodiments, each of the first draft arm 314 and the second draft arm 316 is coupled to one or more actuators 322 that are configured to drive the first draft arm 314 and the second draft arm 316 to rotate relative to the chassis 320 of the vehicle 10. Each of the first draft arm 314 and the second draft arm 316 includes an opening 324 configured to receive a corresponding hitch pin of the implement 300.

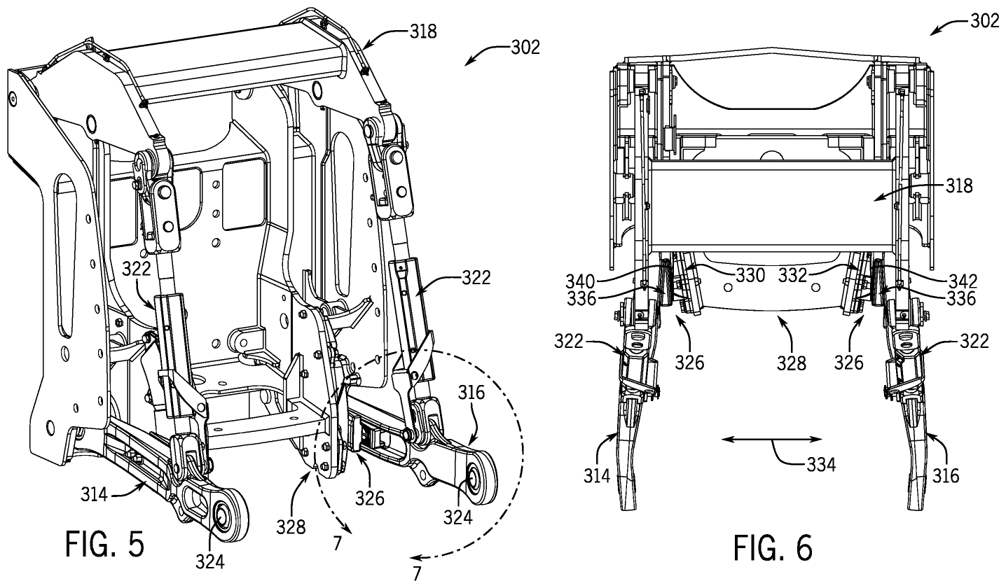

With specific reference to FIGS. 5-7, the first draft arm 314 and the second draft arm 316 both include a wear block assembly 326 that is configured to control lateral movement of the first draft arm 314 and the second draft arm 316 relative to a frame 328 of the three-point hitch 302. The wear block assembly 326 of the first draft arm 314 is arranged between the first draft arm 314 and a first sway block 330, and the wear block assembly 326 of the second draft arm 316 is arranged between the second draft arm 316 and a second sway block 332 (see, e.g., FIG. 6). In general, the wear block assemblies 326 are configured to be selectively adjusted to control a lateral clearance between the wear block assemblies 326 and the respective sway block 330, 332, which controls the amount of lateral movement allowed by the first draft arm 314 and the second draft arm 316, relative to the frame 328, in a lateral direction 334.

Both of the wear block assemblies 326 include a wear block 336 and a wedge block 338. The wear block 336 of the first draft arm 314 is in engagement with a first sway surface 340 of the first sway block 330, and the wear block 336 of the second draft arm 316 is in engagement with a second sway surface 342 of the second sway block 332. In some embodiments, during operation, the engagement between the wear blocks 336 and the respective sway surfaces 340, 342 causes the wear blocks 336 and/or the respective sway surfaces 340, 342 to deteriorate or wear down over time. The deterioration of the wear blocks 336 and/or the sway surfaces 340, 342 increases a clearance between the wear blocks 336 and the respective sway surfaces 340, 342, which increases an amount of lateral movement allowed by the first draft arm 314 and the second draft arm 316 relative to the frame 328. As will be described herein, the wear block assemblies 326 each include an interlocking mechanism that locks a position of the wedge blocks 338 on the respective draft arms 314, 316 and enables a user to quickly adjust the lateral clearance between the wear blocks 336 and the respective sway surfaces 340, 342. It should be appreciated that although a single wear block assembly 326 installed on a draft arm 314, 316 is described below, the following description applies to both of the wear block assemblies 326 and both of the draft arms 314, 316.

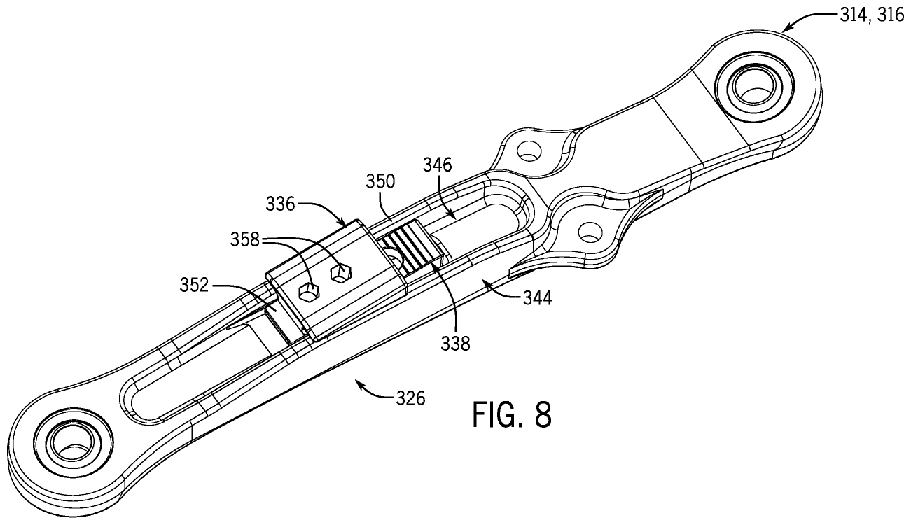

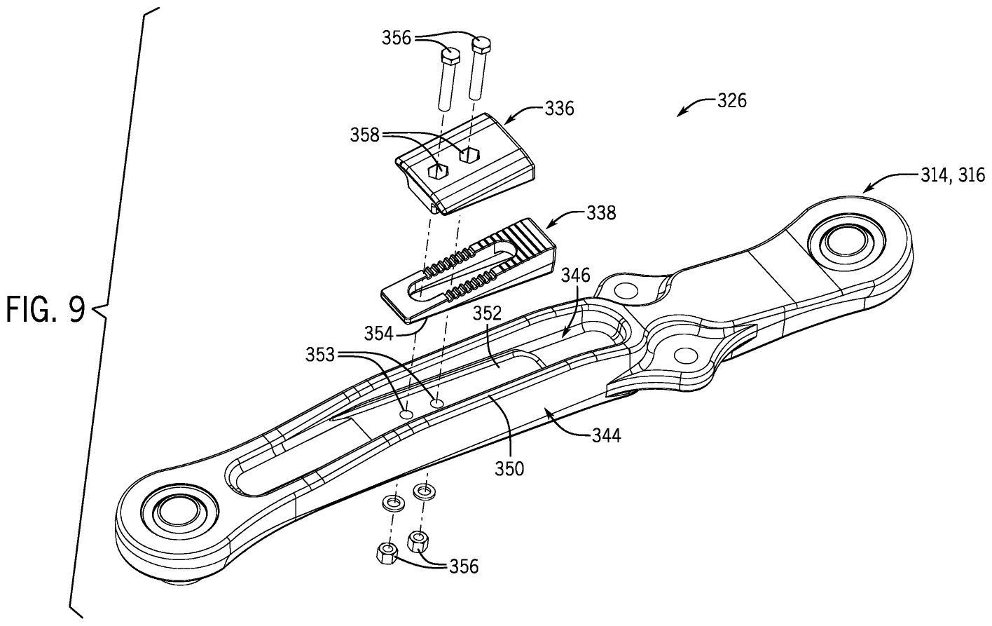

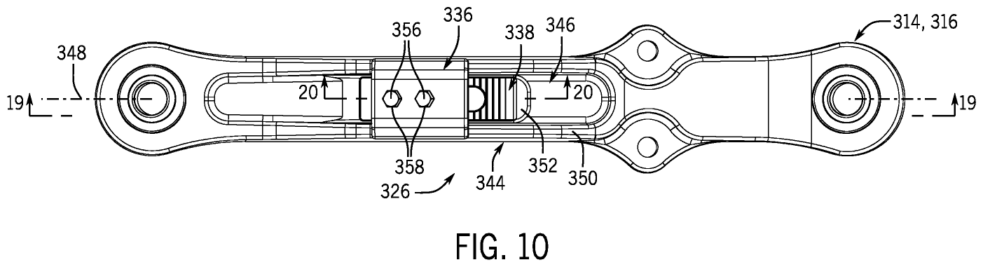

Turning to FIGS. 8-10, the wear block assembly 326 being installed on a draft arm 314, 316 is shown. Both of the draft arms 314, 316 include a body 344 having a draft recess 346 that extends longitudinally along a portion (e.g., a central portion) of the body 344. For example, the draft recess 346 may extend along a longitudinal axis 348 defined by the draft arm 314, 316 (see, e.g., FIG. 10), and the draft recess 346 may be recessed into a top surface 350 of the body 344. The wear assembly 326 may be installed onto the draft arm 314, 316 so that the wedge block 338 is arranged within the draft recess 346. Specifically, the draft recess 346 includes a mounting surface 352 that includes one or more apertures 353 extending through the mounting surface 352 and through the body 344. In some embodiments, the mounting surface 352 defines a planar surface that receives and engages a bottom surface 354 of the wedge block 338. When assembled, the draft recess 346 acts to contain the wedge block 338 within the body 344 and enables the wedge block 338 to be displaced axially (e.g., along the longitudinal axis 348) upon the mounting surface 352.

In the illustrated embodiment, a pair of fasteners 356 are configured to removably couple the wear block 336 and the wedge block 338 to the draft arm 314, 316. In some embodiments, the wear block assembly 326 may include more or less than two fasteners 356 to removably couple the wear block 336 and the wedge block 338 to the draft arm 314, 316. In some embodiments, the pair of fasteners 356 are each in the form of a bolt and nut, with the bolts extending through the wear block 336, the wedge block 338, and the apertures 353 in the mounting surface 352 and the nuts being threaded onto a distal ends of the bolts and engaging a bottom side (e.g., opposite to the top surface 350) of the draft arm 314, 316.

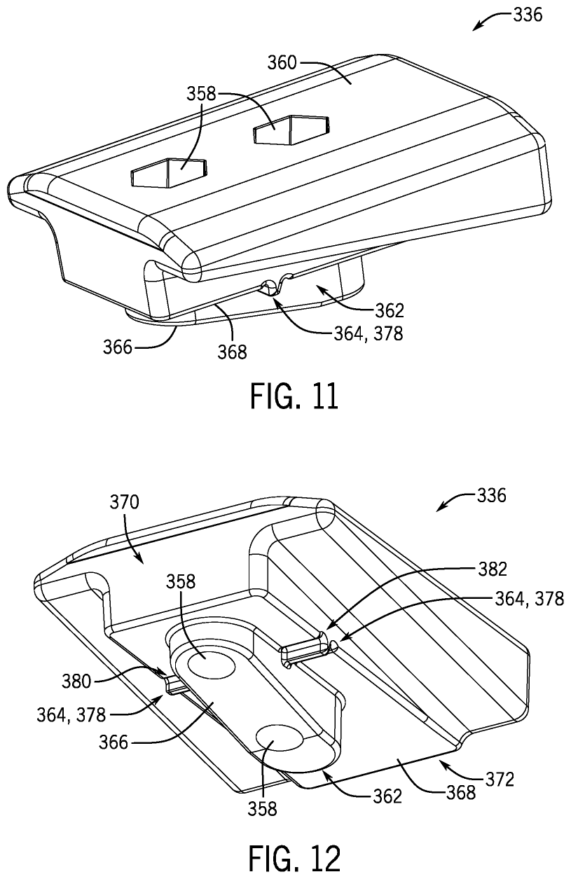

With reference to FIGS. 11-15, the wear block 336 includes a pair of wear apertures 358, a wear surface 360, a central hub 362, and a positive locking feature 364. In some embodiments, the wear block 336 is fabricated from a metal material. In some embodiments, the wear block is fabricated from an austempered ductile iron (e.g., grade 1200). The pair of wear apertures 358 extend through the wear block 336 from the wear surface 360 to an outer surface 366 of the central hub 362 (see, e.g., FIG. 12). Each of the wear apertures 358 is configured to receive a corresponding one of the fasteners 356 therein. In some embodiments, at least a portion of the surfaces that define the wear apertures 358 may define a shape that corresponds to a portion of the fasteners 356. For example, a portion of each of the wear apertures 358 may define a shape that is complementary to a head of the bolts. In this way, for example, when the fasteners 356 are installed into the wear block 336, the fasteners 356 are prevented from rotating within the wear apertures 358.

In some embodiments, the wear surface 360 is an outer surface (e.g., a top surface from the perspective of FIG. 11). When the wear block assemblies 326 are assembled into the three-point hitch 302, the wear surface 360 of the wear block 336 installed on the first draft arm 314 engages the first sway surface 340, and the wear surface 360 of the wear block 336 installed on the second draft arm 316 engages the second sway surface 342 of the second sway block 332. The engagement between the wear surfaces 360 and the sway surfaces 340, 342 wears down the wear surfaces 360 and/or the sway surfaces 340, 342 and increases the lateral clearance between the wear surfaces 360 and the sway surfaces 340, 342, which allows more lateral movement (e.g., sway) of the draft arms 314, 316. As will be described herein, the wear block assembly 326 is configured to enable selective and efficient lateral adjustment of the wear surface 360 by simply loosening the fasteners 356, moving the wedge block 338 relative to the wear block 336, and subsequently retightening the fasteners 356.

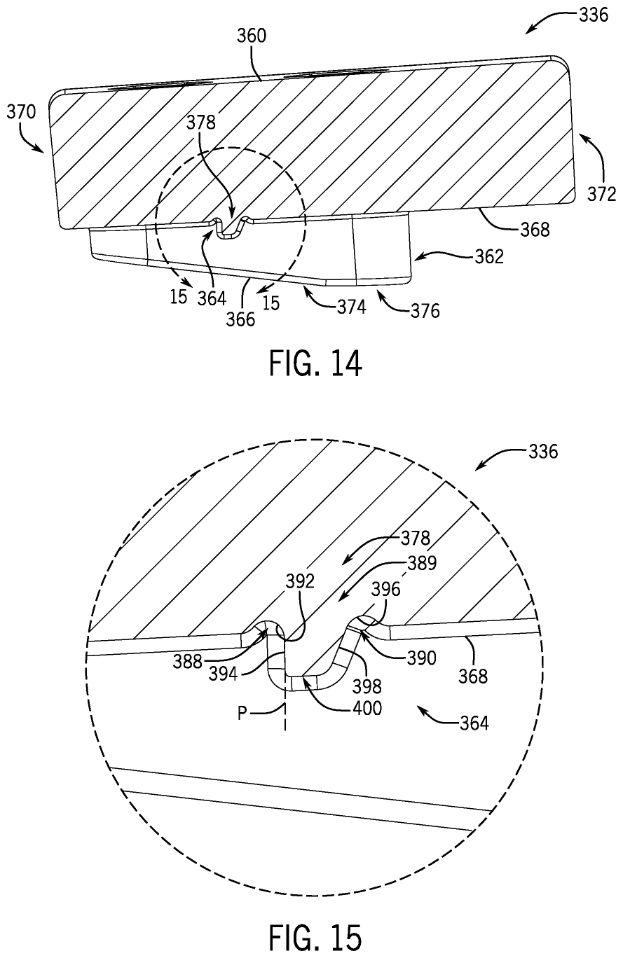

The central hub 362 protrudes outwardly from a contact surface 368 of the wear block 336. The contact surface 368 is arranged generally parallel to the wear surface 360 and on an opposing side of the wear block 336 (e.g., on a bottom side of the wear block 336 from the perspective of FIG. 14). The central hub 362 is arranged on the contact surface 368 between a first end 370 and a second end 372 of the wear block 336. In the illustrated embodiment, the central hub 362 is arranged closer to the first end 370 than the second end 372. When assembled, the contact surface 368 is configured to engage the wedge block 338 and the central hub 362 is configured to be received within a portion of the wear block 338. In the illustrated embodiment, the outer surface 366 of the central hub 362 includes an angled portion 374 and a planar portion 376 (see, e.g., FIG. 14). The angled portion 374 extends from an end of the central hub 362 arranged adjacent to the first end 370 to a junction between the angled portion 374 and the planar portion 376. The planar portion 376 extends from the junction between the angled portion 374 and the planar portion 376 to an end of the central hub 362 arranged adjacent to the second end 372. In some embodiments, the angled portion 374 is arranged at an angle (e.g., an acute angle, or an angle between 5 degrees and 90 degrees) relative to the contact surface 368. For example, a plane extending parallel to the angled portion 374 intersects a plane extending parallel to the contact surface 368 at an angle between about 5 degrees and about 90 degrees, or between about 5 degrees and about 45 degrees, or between about 5 degrees and about 30 degrees. In some embodiments, the planar portion 376 is arranged substantially parallel to the contact surface 368.

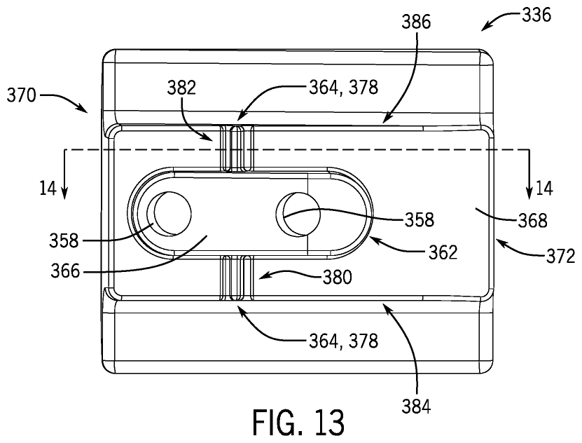

In general, the positive locking feature 364 includes material that protrudes outwardly from a portion of the wear block 336 and is configured to interlock with a negative locking feature that is recessed into a portion of the wedge block 338. In the illustrated embodiment, the positive locking feature 364 is in the form of a tooth or protrusion 378 the extends outwardly from the contact surface 368. The tooth 378 extends laterally across the contact surface 368 and is interrupted by the central hub 362 (i.e., the tooth 378 does not extend along the central hub 362). In other words, the tooth 378 extends laterally across the contact surface 368 on both sides of the central hub 362, but not across the central hub 362. In some embodiments, the tooth 378 includes a first tooth portion 380 and a second tooth portion 382. The first tooth portion 380 extends from a first side 384 of the contact surface 368 (e.g., a side that is arranged perpendicular to the first end 370) to a junction between the first tooth portion 380 and the central hub 362 (see, e.g., FIG. 13). The second tooth portion 382 that extends from a second side 386 of the contact surface 368 (e.g., a side opposite to the first side and arranged perpendicular to the first end 370) to a junction between the second tooth portion 382 and the central hub 362. In general, the first tooth portion 380 and the second tooth portion 382 define the same shape and design, other than being arranged on opposing sides of the central hub 362. As such, features of the tooth 378 described herein apply to both the first tooth portion 380 and the second tooth portion 382. In some embodiments, the tooth 378 can extend laterally across an entirety of the wear block 336 (e.g., over the central hub 362, or across the entire contact surface 368 in embodiment where the central hub 362 is excluded from the wear block 336). In some embodiments, the wear block 336 may include a plurality of teeth 378 (e.g., two or more), each extending laterally along the contact surface 338 and spaced from one another.

In some embodiments, the tooth 378 is positioned directly between the wear apertures 358 and, when assembled, directly between the fasteners 356. In other words, an axis that extends longitudinally along the tooth 378 (e.g., at a center of mass) is centered between the wear apertures 358. This placement of the tooth 378 along the contact surface 368 centers the tooth 378 between the loading forces generated by the fasteners 356 and minimizes fretting of the tooth 378 due to the engagement with the wedge block 338. In some embodiments, the tooth 378 may be positioned at a different location along the contact surface 368. For example, the tooth 378 may be positioned in front of (e.g., toward the first end 370) of the fasteners 356, behind (e.g., toward the second end 372) the fasteners 356, or another location between the fasteners 356 that is not centered between the fasteners 356.

With specific reference to FIG. 15, the tooth 378 includes a leading undercut or recess 388 arranged on a first or leading side of the tooth 378 (e.g., a left side from the perspective of FIG. 15) and a trailing undercut or recess 390 arranged on a second or trailing side of the tooth 378 (e.g., a right side from the perspective of FIG. 15). The leading undercut 388 defines a recess that extends inwardly into the contact surface 368 and at least partially forms a base 389 of the tooth 378. The leading undercut 388 forms a leading curved surface 392 that defines a radius of curvature and extends from the contact surface 368 to a locking face 394 of the tooth 378.

The trailing undercut 390 defines a recess that extends inwardly into the contact surface 368 and at least partially forms a base of the tooth 378. The trailing undercut 390 forms a trailing curved surface 396 that defines a radius of curvature and extends from the contact surface 368 to a tapered surface 398 of the tooth 378, which is arranged on an opposing side of the tooth 378 relative to the locking face 394. In general, the leading undercut 388 and the trailing undercut 390 both act to reduce stress concentrations at the base 389 of the tooth 378 and distribute shear forces acting on the tooth 378 by incorporating the leading curved surface 392 and the trailing curved surface 396. The leading curved surface 392 and the trailing curved surface 396 generally avoid the incorporation of sharp corners at the base 389 of the tooth 378 and increase the surface area at the base 389 of the tooth 378, both of which aid in reducing stress and distributing shear forces. In addition, the leading curved surface 392 aids in aligning the locking face 394 with the wedge block 338 to ensure proper engagement therebetween, as will be described herein.

In general, the locking face 394 is configured to engage a portion of the wedge block 338 to form an interlocking connection between the wear block 336 and the wedge block 338 that locks a position of the wedge block 338 relative to the mounting surface 352. In some embodiments, the locking face 394 extends in a direction that is generally perpendicular to the contact surface 368. The locking face 394 extends along the tooth 378 from a junction between the locking face 394 and the leading curved surface 392 to a distal end 400 of the tooth 378. The locking face 394 defines a locking plane P that is arranged parallel to the locking face 394. As will be described herein, the locking plane P is arranged at an angle (e.g., an acute angle) relative to an axis defined by the fasteners 356 so that the wear block 336 is pulled into engagement with the wedge block 338 as the fasteners 356 are tightened.

The tapered surface 398 extends from the distal end 400 of the tooth 378 to a junction between the tapered surface 398 and the trailing curved surface 396. In general, the tapered surface 398 is arranged at an angle relative to the contact surface 368. In some embodiments, a plane extending along the tapered surface 398 intersects a plane that extends along the contact surface 368 at an angle (e.g., an obtuse angle) between about 100 and about 170 degrees, or between about 110 degrees and about 160 degrees. The tapered surface 398 is angled relative to the contact surface 368 so that a thickness or width of the tooth 378 (e.g., taken along sections that are parallel to a plane defined by the contact surface 368) decreases as the tooth 378 extends from the base 389 to the distal end 400. In other words, the tooth 378 defines a greatest thickness at the base 389 or proximal end thereof, and the tooth 378 gradually decreases in thickness as the tooth protrudes outwardly from the base 389 toward the distal end 400. In this way, for example, the tooth 378 defines a greatest cross-sectional area at the base 389, which aids in preventing the tooth 378 from shearing during side loading forces acting on the wedge block 338.

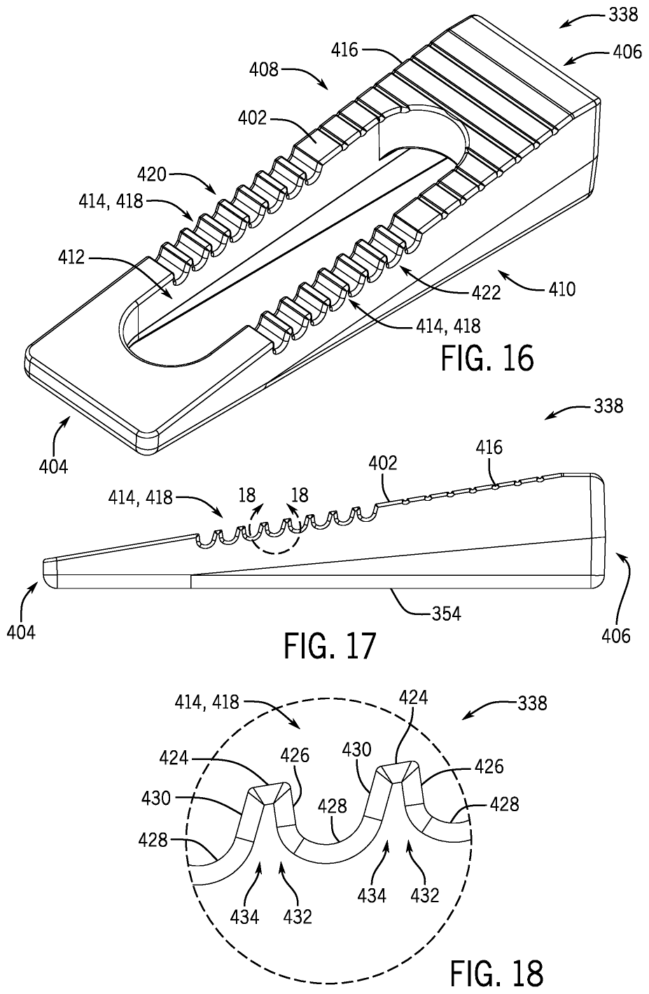

With reference to FIGS. 16-18, the wedge block 338 includes the bottom surface 354, a top surface 402, a first end 404, a second end 406, a first side 408, a second side 410, a wedge cutout 412, and a negative locking feature 414. In some embodiments, the wedge block 338 is fabricated from a metal material. In some embodiments, the wedge block 338 is fabricated from an austempered ductile iron (e.g., grade 900). In some embodiments, the wedge block 338 is fabricated from a metal material with a lower hardness and/or ductility than the metal material of the wear block 336. In some embodiments, the top surface 402 tapers upwardly as the top surface 402 extends in a direction from the first end 404 toward the second end 406. In other words, the top surface 402 slopes upwardly relative to the bottom surface 354 so that a height of thickness of the wedge block 338 increases as the wedge block 338 extends from the first end 404 towards the second end 406. In some embodiments, the taper or slope of the top surface 402 defines an angle (e.g., an acute angle) between the top surface 402 and the bottom surface 354 (and thereby the mounting surface 352). For example, a plate extending along the top surface 402 intersects a plane extending along the bottom surface 354 at an angle between about 5 degrees and about 45 degrees, or between about 10 degrees and about 40 degrees. The angle defined between the top surface 402 and the bottom surface 354 (and thereby the mounting surface 352) enables an axial adjustment (e.g., along the longitudinal axis 348) of the wedge block 338 to result in a change in a lateral position (e.g., along the lateral direction 334, which is perpendicular to the mounting surface 352/the bottom surface 354) of the wear block 336, as will be described herein.

In some embodiments, the wedge block 338 includes a plurality of indicators 416 arranged on the top surface 402 and extending laterally between the first side 408 and the second side 410 and spaced longitudinally from one another (e.g., spaced in a direction between the first end 404 and the second end 406). In some embodiments, the indicators 416 are arranged on the top surface 402 adjacent to the second end 406 of the wedge block 338 and are configured to align with the second end 372 of the wear block 336. In some embodiments, each of the indicators 416 defines a recess that extends inwardly into the top surface 402 and is configured to provide an indication of the relative position between the wear block 336 and the wedge block 338. That is, during adjustment of the wear block 336 relative to the wedge block 338, a user may reference the indicators 416 to determine the amount of relative displacement between the wear block 336 and the wedge block 338.

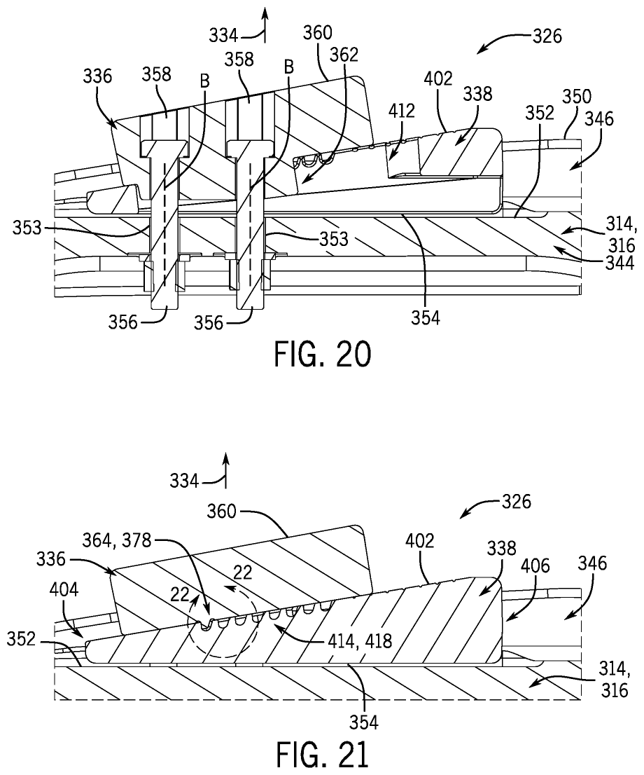

The wedge cutout 412 extends through the top surface 402 and is arranged inwardly from each of the first end 404, the second end 406, the first side 408, the second side 410. The wedge cutout 412 extends longitudinally along and through the top surface 402 and is configured to receive the central hub 362 of the wear block 336 therein (see, e.g., FIG. 20).

In general, the negative locking feature 414 includes material that is recessed inwardly into a portion of the wedge block 338 and is configured to interlock with the positive feature that protrudes from a portion of the wear block 336. In the illustrated embodiment, the negative locking feature 414 is in the form of a plurality of wedge recesses or cutouts 418 that extend inwardly into and laterally along the top surface 402 of the wedge block 338. In some embodiments, the wedge block 338 includes about eight wedge recesses 418. In some embodiments, the wedge block 338 includes more or less than eight wedge recesses 418, depending on the desired resolution for the lateral adjustment of the wear block 336.

Each of the wedge recesses 418 extends laterally along the top surface 402 between the first side 408 and the second side 410. In some embodiments, each of the wedge recesses 418 is interrupted by the wedge cutout 412, which forms a first wedge recess portion 420 arranged adjacent to the first side 408 and a second wedge recess portion 422 arranged adjacent to the second side 410. In some embodiments, the first tooth portion 380 is configured to interlock with a corresponding one of the first wedge recess portions 420 and the second tooth portion 382 is configured to interlock with a corresponding one of the second wedge recess portions 422. In general, the first wedge recess portions 420 and the second wedge recess portions 422 defined the same shape and design, other than being arranged on opposing sides of the wedge block 338. As such, the features of the wedge recesses 418 described herein apply to both the first wedge recess portions 420 and the second wedge recess portions 422.

In some embodiments, the wedge recesses 418 are spaced from one another longitudinally along the top surface 402 (e.g., in a direction extending between the first end 404 and the second end 406). Because of the slope or angle defined by the top surface 402, each of the wedge recesses 418 is arranged at a different height along the top surface 402. In this way, for example, the wedge recesses 418 may define a gradually increasing height relative to the bottom surface 354 (and thereby to the mounting surface 352) as the wedge recesses 418 are spaced in a direction from the first end 404 toward the second end 406. In some embodiments, a first wedge recess arranged closest to the first end 404 of the wedge block 338 defines a first height between a lowermost point of the first wedge recess and the bottom surface 354 (e.g., measured in a direction perpendicular to the bottom surface 354). A second wedge recess arranged immediately adjacent to the first wedge recess, moving in a direction toward the second end 406, defines a second height between the lowermost point in the second wedge recess and the bottom surface 354, and a third wedge recess arranged immediately adjacent to the second wedge recess, moving in a direction toward the second end 406, defines a third height between the lowermost point in the third wedge recess and the bottom surface 354. In some embodiments, the second height of the second wedge recess is greater than the first height of the first wedge recess, and the third height of the third wedge recess is greater than the second height of the second wedge recess, and so on for each adjacent pair of wedge recesses 418. In some embodiments, an incremental height increase between each adjacent pair of wedge recesses 418 is approximately constant or equal. For example, the difference between the second height of the second wedge recess and the first height of the first wedge recess is approximately equal to the difference between the third height of the third wedge recess and the second height of the second wedge recess. In some embodiments, the incremental increase in height between adjacent pairs of the wedge recesses 418 is between about 1 millimeter (mm) and 2 mm, or about 1.7 mm. In some embodiments, the incremental increase in height between adjacent pairs of the wedge recesses 418 is less than 1 mm, or more than 2 mm.

With specific reference to FIG. 18, each of the wedge recesses 418 includes a recess contact surface 424, a securing face 426, a recess curved surface 428, and a recess tapered surface 430. The recess contact surface 424 is arranged at a distal end of each of the wedge recesses 418 and forms part of the top surface 402 (i.e., the recess contact surface 424 defines the same slope or angle of the top surface 402). The securing face 426 of each of the wedge recesses 418 extends generally perpendicular to the recess contact surface 424 in a direction toward the bottom surface 354. In general, the securing face 426 is configured to engage the locking face 394 of the tooth 378 to form an interlocking connection between the wear block 336 and the wedge block 338. The securing face 426 extends from a junction between the recess contact surface 424 and the securing face 426 to a junction between the securing face 426 and the recess curved surface 428. In some embodiments, the recess curved surface 428 of each of the wedge recesses 418 defines a gradually increasing radius of curvature as the recess curved surface 428 extends in a direction toward the recess tapered surface 430 (e.g., toward the right from the perspective of FIG. 18). In some embodiments, the radius of curvature defined by the recess curved surface 428 adjacent to the securing face 426 is less than the radius of curvature defined by the recess curved surface 428 adjacent to the recess tapered surface 430. In this way, for example, the recess curved surface 428 provides additional cross-sectional area over which the contact stress and/or shear forces at the securing face 426 can be distributed. In addition, the recess curved surface 428 provides a smooth area (e.g., no sharp corners) over which the contact stress and/or shear force is distributed. Further, the shape of the recess curved surface 428 and the recess tapered surface 430 aid in increasing an amount of material in between adjacent wedge recesses 418, which aids in preventing shearing of the material between adjacent wedge recesses 418 as the securing face 426 is brought into engagement with the locking face 394 as described herein. For example, a wedge protrusion 432 can be defined between each adjacent pair of the wedge recesses 418 and a thickness or width of the each of the wedge protrusions 432 (e.g., measured in a direction parallel to the top surface 402) increases as it extends from the recess contact surface 424 toward a base 434. This increasing thickness at the base 434 aids in distributing shear forces acting on the securing face 426 over a large area, which helps prevent shearing of wedge protrusions 432.

Like the recess curved surface 428, the recess tapered surface 430 of each of the wedge recesses 418 is configured to further increase the cross-sectional area over which the contact stress and/or shear force at the securing face 426 can be distributed. The recess tapered surface 430 extends from a junction between the recess curved surface 428 and the recess tapered surface 430 to a junction between the recess tapered surface 430 and the recess contact surface 424 of an adjacent wedge recess 418 (or the top surface 402 for the wedge recess 418 arranged closest to the second end 406). The recess tapered surface 430 defines a slope or angle so that a portion of the recess tapered surface 430 arranged adjacent to the recess curved surface 438 is arranged closer to the securing face 426 than a portion of the recess tapered surface 430 arranged adjacent to the recess contact surface 424 of a subsequent wedge recess 418. In other words, a plane extending along the recess tapered surface 430 intersects a plane extending along the top surface 402 at an angle (e.g., an obtuse angle) between about 100 and about 170 degrees, or between about 110 degrees and about 160 degrees. The angle or slope of the recess tapered surface 430 increases an area defined with each of the wedge recesses 418 and increases a thickness at the base 434 of each wedge protrusion 432.

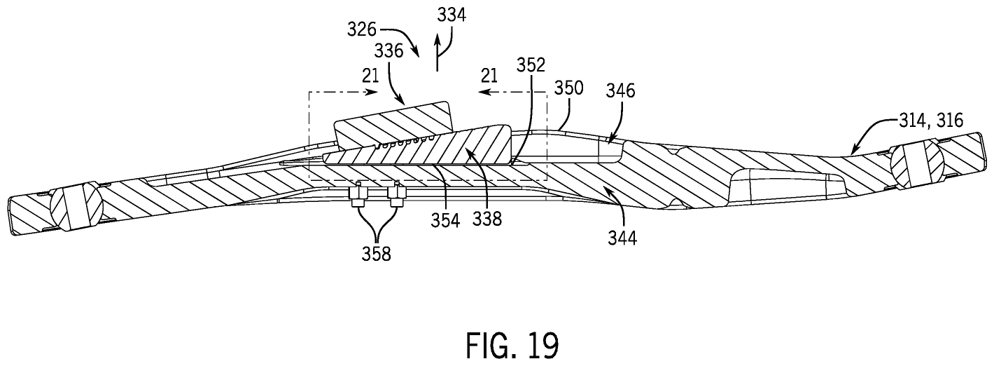

With reference to FIGS. 19-22, the wear block assembly 326 can be installed on the draft arm 314, 316 by initially placing the wedge block 338 within the recess 346 so that the bottom surface 354 of the wedge block 338 engages the mounting surface 352 within the recess 346. The wear block 336 can then be installed onto the wedge block 338 so that the tooth 378 is arranged within one of the wedge recesses 418. In some embodiments, the wear block 336 is initially installed on the wedge block 338 so that the tooth 378 is arranged within the wedge recess 418 that is arranged closest to the first end 404 of the wedge block 338 (see, e.g., FIG. 21). In this way, for example, the wear block 336 and the wear surface 360 may be arranged at the lowest lateral position along the lateral direction 334 (e.g., a lowest height above the mounting surface 352). In some embodiments, the wear block 336 may be initially installed on the wedge block 338 so that the tooth 378 is arranged within any one of the wedge recesses 418 to accommodate the clearance between the wear surfaces 360 and the sway surfaces 340, 342 and ensure engagement between the wear surfaces 360 and the sway surfaces 340, 342.

With the wear block 336 loosely installed on the wedge block 338, the fasteners 356 can be installed onto the wear block assembly 326 to secure the wear block 336 and the wedge block 338 to the draft arm 314, 316 (see, e.g., FIG. 20). For example, the bolts may be inserted through the wear apertures 358 in the wear block 336 and the apertures 353 in the mounting surface 352, and the nuts may be threaded onto a distal end of the bolts to tighten and secure the wear block assembly 326 to the draft arm 314, 316. With the fasteners 356 installed in the wear block assembly 326, the fasteners 356 extend along parallel bolt axes B. In some embodiments, the bolt axis B is arranged perpendicular to the mounting surface 352.

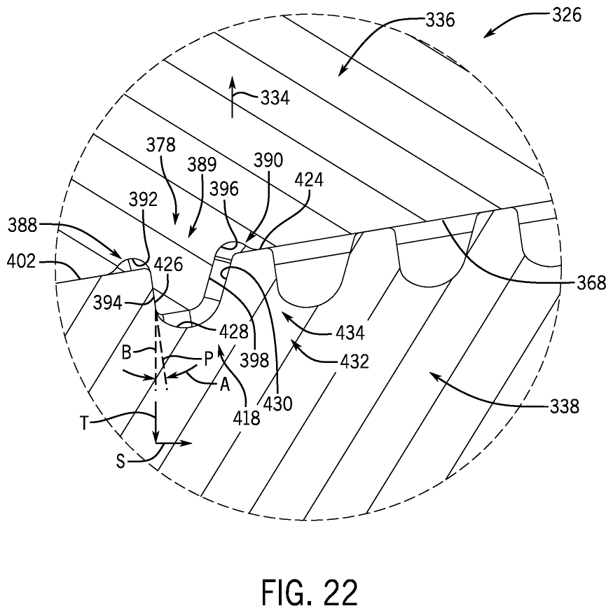

With specific reference to FIG. 22, the plane P that is parallel to the locking face 394 is arranged at an angle A relative to the bolt axis B. In some embodiments, the angle A is an acute angle. In some embodiments, the angle A is between about 5 degrees and about 60 degrees, or between about 5 degrees and about 45 degrees, or between about 5 degrees and 30 degrees. In any case, the angle A defined between the plane P and the bolt axis B is configured to displace the wedge block 338 relative to the wear block 336 as the fasteners 356 are tightened. Specifically, as the fasteners 356 are tightened, a tightening force T is produced along the bolt axis B. Because the plane P is offset by the angle A relative to this tightening force T, a shifting force S is generated on the wedge block 338. The shifting force S is generated in a direction that is normal to the tightening force T and points toward the second end 406 of the wedge block 338 (e.g., to the right from the perspective of FIG. 22). The magnitude and direction of the shifting force S, which are governed by the angle A, act to displace the wedge block 338 so that the securing face 426 is driven into engagement with the locking face 394 to form a tight joint therebetween. As such, the design of the wear block 336 and the wedge block 338 are configured to naturally form a tight joint between the securing face 426 and the locking face 394 as the wear block 336 and the wedge block 338 are fastened together.

The leading undercut 388 and the leading curved surface 392 provide a clearance between the locking face 394 and the securing face 426 as the tooth 378 is installed with the wedge recess 418. Specifically, the leading curved surface 392 does not engage with the top surface 402 (or the recess contact surfaces 424 when the tooth 378 is installed with a wedge recess 418 other than the one arranged closest to the first end 404) and this provides more room for the locking face 394 to shift as the wear block 336 is installed onto the wedge block 338 and form a tight joint between the locking face 394 and the securing face 426.

In general, the joint formed by the engagement between the securing face 426 and the locking face 394 interlocks the wedge block 338 to the wear block 336. Because the wear block 336 is secured to the draft arm 314, 316 by the fasteners 356, the interlocking connection between the locking face 394 and the securing face 426 prevents the wedge block 338 from moving relative to the wear block 336 during operation. As such, the wear block assembly 326 prevents the relative shifting of a wedge block in conventional wear block assemblies experienced, for example, in lateral loading conditions.

Further, the wear block assembly 326 enables efficient and timely adjustment of the lateral position of the wear surface 360 relative to the frame 328 (e.g., the sway surfaces 340, 342). As described herein, the wear surfaces 360 and/or the sway surfaces 340, 342 may wear down over time, which increases the lateral movement allowed by the draft arms 314, 316. To adjust a lateral position of the wear surface 360 (e.g., relative to the respective draft arm 314, 316), a user may loosen the fasteners 356 to provide enough clearance for the tooth 378 to pass over the adjacent wedge protrusion 432. Once there is sufficient clearance, a user may displace the wedge block 338 to align the tooth 378 with an adjacent wedge recess 418 that is arranged closer to the second end 406 of the wedge block 338. Moving the tooth 378 into an adjacent wedge recess 418 that is arranged closer to the second end 406, raises the lateral position of the wear surface 360 along the lateral direction 334 (e.g., relative to the mounting surface 352 of the respective draft arm 314, 316) and reduces or eliminates the clearance between the wear surface 360 and the respective sway surface 340, 342, which correspondingly reduces the amount of lateral movement allowed by the respective draft arm 314, 316. As such, a user may incrementally step the wear surface 360 closer to the respective sway surface 340, 342 by moving the tooth 378 incrementally along the wedge recesses 418, which provides continual lateral adjustment of the wear surface 360 without requiring an additional part (e.g., a shim). That is, each of the wedge recesses 418 defines a different lateral position of the wear surface 360 relative to the mounting surface 352 of the respective draft arm 314, 316. In addition, the lateral adjustment of the wear block 336 occurs without altering a pivot point along the draft arm 314, 316 (i.e., a location of the wear block 336 along the draft arm 314, 316). That is, there is no longitudinal adjustment (e.g., movement along the longitudinal axis 348) of the wear block 336 while adjusting the lateral position of the wear block 336. This ensures that the dynamic forces experienced along the draft arms 314, 316 are not changed by the adjustment of the wear block 336 and maintains the structural integrity of the draft arms 314, 316.

As utilized herein with respect to numerical ranges, the terms “approximately,” “about,” “substantially,” and similar terms generally mean+/−10% of the disclosed values, unless specified otherwise. As utilized herein with respect to structural features (e.g., to describe shape, size, orientation, direction, relative position, etc.), the terms “approximately,” “about,” “substantially,” and similar terms are meant to cover minor variations in structure that may result from, for example, the manufacturing or assembly process and are intended to have a broad meaning in harmony with the common and accepted usage by those of ordinary skill in the art to which the subject matter of this disclosure pertains. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References herein to the positions of elements (e.g., “top,” “bottom,” “above,” “below”) are merely used to describe the orientation of various elements in the figures. It should be noted that the orientation of various elements may differ according to other exemplary embodiments, and that such variations are intended to be encompassed by the present disclosure.

The hardware and data processing components used to implement the various processes, operations, illustrative logics, logical blocks, modules, and circuits described in connection with the embodiments disclosed herein may be implemented or performed with a general purpose single- or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device) may include one or more devices (e.g., RAM, ROM, Flash memory, hard disk storage) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit or the processor) the one or more processes described herein.

The present disclosure contemplates methods, systems, and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

It is important to note that the construction and arrangement of the vehicle 10 and the systems and components thereof (e.g., the driveline 50, the braking system 100, the control system 200, the three-point hitch 302, the wear block assemblies 326, etc.) as shown in the various exemplary embodiments is illustrative only. Additionally, any element disclosed in one embodiment may be incorporated or utilized with any other embodiment disclosed herein.

What is claimed is:

1. A wear block assembly for a three-point hitch, comprising:
a wedge block including a top surface and a bottom surface, wherein the top surface includes a wedge recess that extends laterally along the top surface; and
a wear block including a tooth that protrudes from a contact surface, wherein the tooth is configured to be received within the wedge recess and engage a securing face of the wedge recess to interlock the wedge block and the wear block.

2. The wear block assembly of claim 1, wherein the wear block includes a wear surface.

3. The wear block assembly of claim 2, wherein the top surface includes a plurality of wedge recesses, each extending laterally along the top surface and being spaced from one another along a longitudinal direction between a first end of the wedge block and a second end of the wedge block.

4. The wear block assembly of claim 3, wherein each of the plurality of wedge recesses defines a different height of the wear surface relative to the bottom surface.

5. The wear block assembly of claim 1, wherein the wear block is coupled to the wedge block by a fastener, and wherein the fastener extends along a bolt axis.

6. The wear block assembly of claim 5, wherein the tooth includes a locking face that extends along a plane, and wherein the plane of the locking face is arranged at an angle relative to the bolt axis.

7. The wear block assembly of claim 6, wherein the angle between the plane of the locking face and the bolt axis is configured to generate a shifting force on the wedge block as the fastener is tightened, and wherein the shifting force is configured to displace the wedge block relative to the wear block so that the locking face is brought into engagement with the securing face.

8. The wear block assembly of claim 1, wherein the top surface of the wedge block is arranged at an angle relative to the bottom surface of the wedge block.

9. A wear block assembly for a three-point hitch, comprising:
a wedge block including a first end, a second end, a bottom surface, and a top surface, wherein the top surface includes a plurality of wedge recesses, each extending laterally along the top surface and being spaced from one another along a longitudinal direction between the first end and the second end; and
a wear block including a wear surface, a contact surface, and a tooth that protrudes from the contact surface, wherein the tooth is configured to be received within one of the plurality of wedge recesses, and wherein each of the plurality of wedge recesses defines a different height of the wear surface relative to the bottom surface.

10. The wear block assembly of claim 9, wherein the top surface of the wedge block is arranged at an angle relative to the bottom surface of the wedge block.

11. The wear block assembly of claim 9, wherein each of wedge recesses includes a securing face, and wherein the tooth is configured to engage one of the securing faces to interlock the wedge block and the wear block.

12. The wear block assembly of claim 11, wherein the wear block is coupled to the wedge block by a fastener, and wherein the fastener extends along a bolt axis.

13. The wear block assembly of claim 12, wherein the tooth includes a locking face that extends along a plane, and wherein the plane of the locking face is arranged at an angle relative to the bolt axis.

14. The wear block assembly of claim 13, wherein the angle between the plane of the locking face and the bolt axis is configured to generate a shifting force on the wedge block as the fastener is tightened, and wherein the shifting force is configured to displace the wedge block relative to the wear block so that the locking face is brought into engagement with the securing face.

15. A three-point hitch for a vehicle, comprising:
a frame including a sway surface; and
a draft arm including a wear block assembly, the wear block assembly including:
a wedge block including a first end, a second end, a bottom surface, and a top surface, wherein the top surface includes a plurality of wedge recesses, each extending laterally along the top surface and being spaced from one another along a longitudinal direction between the first end and the second end; and
a wear block including a wear surface configured to engage the sway surface, a contact surface, and a tooth that protrudes from the contact surface, wherein the tooth is configured to be received within one of the plurality of wedge recesses, and wherein each of the plurality of wedge recesses defines a different lateral position of the wear surface relative to the draft arm.

16. The three-point hitch of claim 15, wherein the top surface of the wedge block is arranged at an angle relative to the bottom surface of the wedge block.

17. The three-point hitch of claim 15, wherein each of wedge recesses includes a securing face, and wherein the tooth is configured to engage one of the securing faces to interlock the wedge block and the wear block.

18. The three-point hitch of claim 17, wherein the wear block is coupled to the wedge block by a fastener, and wherein the fastener extends along a bolt axis.

19. The three-point hitch of claim 18, wherein the tooth includes a locking face that extends along a plane, and wherein the plane of the locking face is arranged at an angle relative to the bolt axis.

20. The three-point hitch of claim 19, wherein the angle between the plane of the locking face and the bolt axis is configured to generate a shifting force on the wedge block as the fastener is tightened, and wherein the shifting force is configured to displace the wedge block relative to the wear block so that the locking face is brought into engagement with the securing face.
